(19) United States
(12) Patent Application Publication
(10) Pub. No.: US 2006/0093039 A1
(43) Pub. Date: May 4, 2006

(54) Video image encoding method and video image encoding apparatus

(75) Inventors: Goki Yasuda, Kawasaki-shi (JP); Takeshi Chujo, Yokohama-shi (JP)

Correspondence Address: NIXON & VANDERHYE, PC, 901 NORTH GLEBE ROAD, 11TH FLOOR, ARLINGTON, VA, 22203, US

(73) Assignee: Kabushiki Kaisha Toshiba, Tokyo, JP (US)

(21) Appl. No.: 11/264,380

(22) Filed: Nov. 2, 2005

(30) Foreign Application Priority Data
Nov. 2, 2004 (JP) P2004-318879

(51) Int. Cl. H04N 11/02; H04N 11/04; H04N 7/12; H04B 1/66

(52) U.S. Cl. 375/240.16; 375/240.18; 375/240.12; 375/240.03

(57) ABSTRACT

A video image encoding method includes: obtaining a first motion vector that indicates relevancy between an input image that is to be encoded and a locally decoded image that is decoded from an encoded image; generating a filter for the locally decoded image, the filter that minimizes an error between the input image and an image obtained by performing motion compensation for a reference image using the first motion vector; generating the reference image by filtering the locally decoded image by the filter; obtaining a second motion vector that indicates relevancy between the input image and the reference image; generating a predictive image by performing motion compensation for the reference image using the second motion vector; and encoding a predictive error that is quantized by orthogonally transforming and quantizing a predictive error between the predictive image and the input image.

### RELATED APPLICATIONS

The present disclosure relates to the subject matter contained in Japanese Patent Application No. 2004-318879 filed on Nov. 2, 2004, which is incorporated herein by reference in its entirety.

### BACKGROUND OF The INVENTION

1. Field of the Invention

The present invention relates to a video image encoding apparatus, a video image encoding method, a video image decoding apparatus and a video image decoding method for encoding and decoding an image of an encoding target with high accuracy.

2. Description of the Related Art

Conventionally, a method for using a motion compensated prediction has been widely known as one of video image encoding techniques. In a video image encoding apparatus using the motion compensated prediction, a motion vector between an input image which attempts to be encoded and an image (locally decoded image) in which the image already encoded is decoded inside the video image encoding apparatus is first obtained. Next, using the locally decoded image and the motion vector obtained, motion compensation is made and a predictive image for the input image is generated. An orthogonal transform of a predictive error between the input image and the predictive image generated thus is performed and the orthogonal transform factor is quantized and is sent to a decoding apparatus together with the motion vector used in the motion compensated prediction. The decoding apparatus receives the motion vector and the predictive error encoded by the encoding apparatus thus, and generates a new predictive image using a decoded image already decoded in the decoding apparatus, and decodes the original image using this predictive image and the predictive error.

In a video image encoding method for making the motion compensated prediction and generating the predictive image thus, it is necessary to decrease the predictive error between the input image and the predictive image in order to prevent degradation in quality of the decoded image for the input image.

A method for decreasing the predictive error includes, for example, a video image encoding method configured so that a virtual pixel called a sub-pel pixel (pixel at sub-pel position) generated using an interpolation filter is first interpolated between pixels at full-pel position (full-pel pixels) originally present in a locally decoded image and a motion vector is next obtained between an input image and a locally decoded image (hereinafter called an interpolated image) in which this sub-pel pixel is interpolated and thereby the motion vector can be obtained in finer resolution (for example, see the document identified below, which will be referred to as “Adaptive Interpolation Filter for Motion Compensated Prediction”) Also, a method for generating an interpolation filter for generating a sub-pel pixel so that the predictive error between an input image and a predictive image becomes smaller by adaptively changing a filter factor of an interpolation filter for generating a sub-pel pixel with respect to an input image further at this time has been proposed (for example, see “Adaptive Interpolation Filter for Motion Compensated Prediction”).

T. Wedi, “Adaptive Interpolation Filter for Motion Compensated Prediction,” Proc. IEEE International Conference on Image Processing, Rochester, N.Y. USA, September 2002

According to the conventional video image encoding method disclosed in “Adaptive Interpolation Filter for Motion Compensated Prediction” as described above, when a motion vector between an input image and an interpolated image points at a sub-pel pixel of the interpolated image, a predictive error between the input image and a predictive image can be decreased by adaptively changing an interpolation filter in response to the input image.

However, when a motion vector between an interpolated image and an input image points at full-pel pixels, which is pixels at full-pel position (that is, a pixel originally present in a locally decoded image), of the interpolated image even in the case of interpolating a locally decoded image by a sub-pel pixel, the full-pel pixel of the interpolated image does not change by changing an interpolation filter, so that an effect of decreasing a predictive error between the input image and a predictive image cannot be acquired.

### SUMMARY OF The INVENTION

The present invention is directed to a video image encoding method, a video image encoding apparatus, a video image decoding method and a video image decoding apparatus in which a filter for a locally decoded image is generated so as to reduce an error between an input image and an image acquired by performing motion compensation for an image (hereinafter called a reference image) acquired by filtering the locally decoded image and a predictive image is generated from the reference image acquired using this filter and thereby a predictive error between the input image and the predictive image can be reduced.

According to a first aspect of the invention, there is provided a video image encoding method including: obtaining a first motion vector that indicates relevancy between an input image that is to be encoded and a locally decoded image that is decoded from an encoded image; generating a filter for the locally decoded image, the filter that minimizes an error between the input image and an image obtained by performing motion compensation for a reference image using the first motion vector; generating the reference image by filtering the locally decoded image by the filter; obtaining a second motion vector that indicates relevancy between the input image and the reference image; generating a predictive image by performing motion compensation for the reference image using the second motion vector; and encoding a predictive error that is obtained by orthogonally transforming and quantizing a predictive error between the predictive image and the input image.

According to a second aspect of the invention, there is provided a video image encoding method including: obtaining a first motion vector that indicates relevancy between an input image that is to be encoded and a locally decoded image that is decoded from an encoded image; generating a filter for the locally decoded image, the filter that minimizes an error between the input image and an image obtained by performing motion compensation for a reference image using the first motion vector; generating the reference image by filtering the locally decoded image by the filter; obtaining a second motion vector that indicates relevancy between the input image and the reference image; generating a predictive image by filtering by the filter an image acquired by performing motion compensation for the locally decoded image using the second motion vector; and encoding a predictive error that is obtained by orthogonally transforming and quantizing a predictive error between the predictive image and the input image.

According to a third aspect of the invention, there is provided a video image encoding apparatus including: a motion estimation unit that obtains a first motion vector that indicates relevancy between an input image that is to be encoded and a locally decoded image that is decoded from an encoded image, and a second motion vector that indicates relevancy between the input image and a reference image that is obtained by filtering the locally decoded image by a filter; a filter generation unit that generates the filter for the locally decoded image, the filter that minimizes an error between the input image and an image obtained by performing motion compensation for the reference image using the first motion vector; a reference image generation unit that generates the reference image by filtering the locally decoded image by the filter; and a predictive image generation unit that generates a predictive image by performing motion compensation for the reference image using the second motion vector.

According to a fourth aspect of the invention, there is provided a video image decoding method including: decoding an encoded data to obtain a quantized orthogonal transform factor, a motion vector, and a filter for generating a reference image; generating a predictive error signal by performing an inverse quantization and an inverse orthogonal transform for the quantized orthogonal transform factor; generating the reference image by filtering a decoded image by the filter; generating a predictive image from the reference image and the motion vector; generating the decoded image from the predictive image and the predictive error signal.

According to a fifth aspect of the invention, there is provided a video image decoding apparatus including: a decoding unit that decodes an encoded data to obtain a quantized orthogonal transform factor, a motion vector, and a filter for generating a reference image; a signal generating unit that generates a predictive error signal by performing an inverse quantization and an inverse orthogonal transform for the quantized orthogonal transform factor; a reference image generating unit that generates a reference image by filtering a decoded image by the filter; a predictive image generating unit that generates a predictive image from the reference image and the motion vector; and a decoded image generating unit that generates the decoded image from the predictive image and the predictive error signal.

### BRIEF DESCRIPTION OF THE DRAWINGS

In the accompanying drawings:

FIG. 1 is a block diagram showing a configuration of a video image encoding apparatus according to an embodiment;

FIG. 2 is a block diagram showing a configuration of a motion compensated predictor of the video image encoding apparatus according to the embodiment;

FIG. 3 is a flowchart showing an action of the video image encoding apparatus according to the embodiment;

FIG. 4 is a flowchart showing an action of the motion compensated predictor of the video image encoding apparatus according to the embodiment;

FIG. 5 is a diagram representing a filter for locally decoded image of the embodiment;

FIG. 6 is a block diagram showing a configuration of a video image decoding apparatus according to an embodiment;

FIG. 7 is a flowchart showing an action of the video image decoding apparatus according to the embodiment;

FIG. 8 is an explanatory drawing for describing a method using an interpolation filter;

FIG. 9 is an explanatory drawing for describing a weighted prediction method; and

FIG. 10 is an explanatory drawing for describing a concept of the method used in the embodiments.

### DETAILED DESCRIPTION OF THE EMBODIMENTS

Embodiments of the invention will be described below.

### First Embodiment

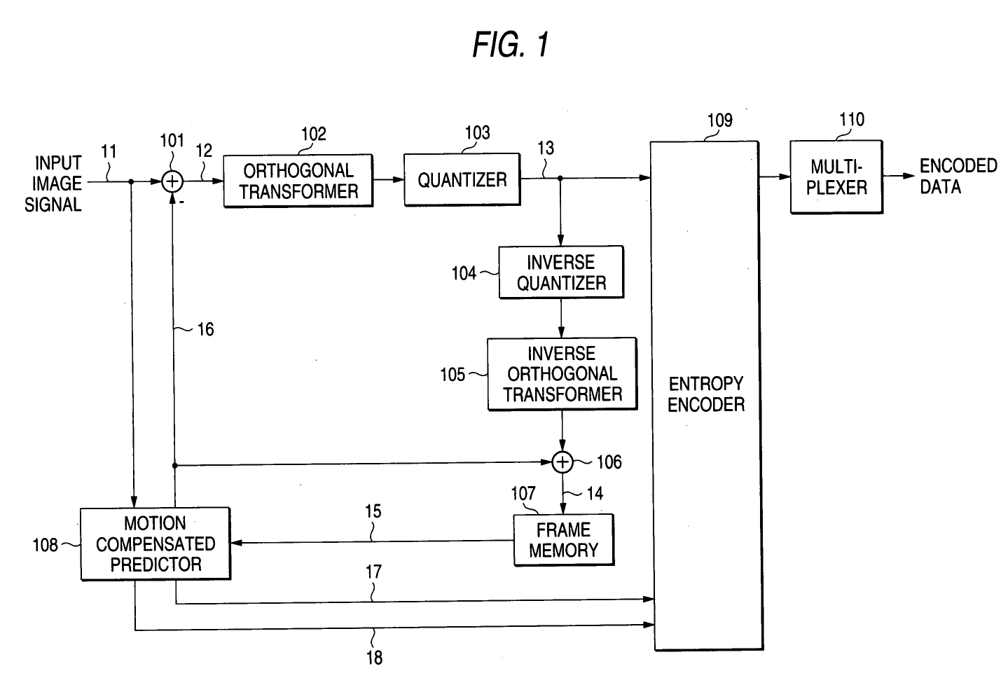

FIG. 1 is a block diagram showing a video image encoding apparatus according to a first embodiment.

The video image encoding apparatus according to this first embodiment includes a subtracter 101 for generating a predictive error signal 12 from an input image signal 11 and a predictive image signal 16, an orthogonal transformer 102 for performing an orthogonal transform of the predictive error signal 12, a quantizer 103 for quantizing an orthogonal transform factor acquired by the orthogonal transformer 102, an inverse quantizer 104 for inversely quantizing the orthogonal transform factor quantized by the quantizer 103, an inverse orthogonal transformer 105 for performing an inverse orthogonal transform of the orthogonal transform factor inversely quantized by the inverse quantizer 104 and reproducing a predictive error signal, an adder 106 for adding the predictive image signal 16 to the predictive error signal reproduced and generating a locally decoded image signal 14, frame memory 107 for storing the locally decoded image signal 14, and a motion compensated predictor 108 for making a motion compensated prediction from the input image signal 11 and a locally decoded image signal 15 read out of the frame memory 107 and generating the predictive image signal 16.

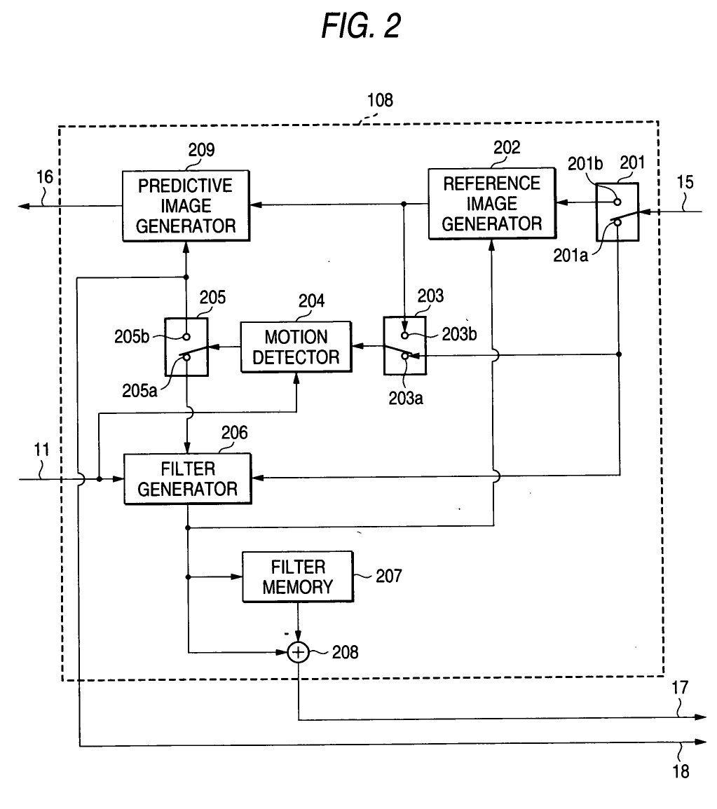

FIG. 2 is a block diagram showing a configuration of the motion compensated predictor 108 according to the first embodiment.

The motion compensated predictor 108 includes a switch 201 for switching an input destination of the locally decoded image signal 15, a reference image generator 202 for generating a reference image signal from the locally decoded image signal 15, a switch 203 for switching a signal inputted to a motion detector 204 in conjunction with the switch 201, the motion detector 204 for obtaining a motion vector from the input image signal 11 and the reference image signal or the locally decoded image signal 15 selected by the switch 203, a switch 205 for switching an output destination of the motion vector obtained by the motion detector 204 in conjunction with the switch 201 and the switch 203, a filter generator 206 for generating a filter for the locally decoded image signal 15 from the input image signal 11 and the locally decoded image signal 15 and the motion vector obtained by the motion detector 204, filter memory 207 for storing a filter generated by the filter generator 206, a subtracter 208 for computing a difference between a filter stored in the filter memory 207 and a filter generated by the filter generator 206, and a predictive image generator 209 for generating the predictive image signal 16 from the reference image signal generated by the reference image generator 202 and the motion vector obtained by the motion detector 204.

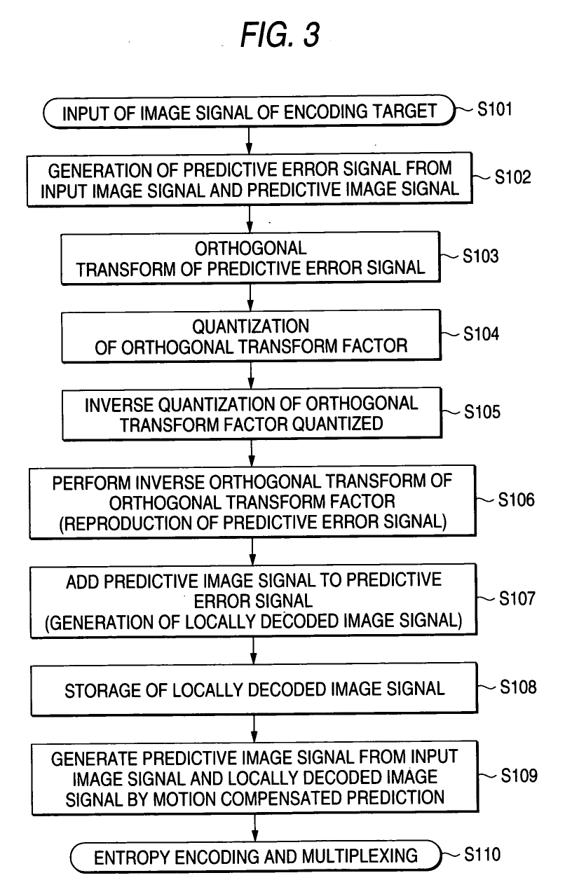

Next, an action of the video image encoding apparatus according to the first embodiment of the invention will be described with reference to FIGS. 1-3. FIG. 3 is a flowchart showing an action of the video image encoding apparatus according to the first embodiment.

First, a video image signal of an encoding target is inputted to the video image encoding apparatus (step S101) Here, the video image signal includes time series static image data, and the static image data of each time is inputted to the video image encoding apparatus as the input image signal 11. Hereinafter the static image data of each time will be called “frame.”

Next, in the subtracter 101, a difference between pixel values of the corresponding pixels is computed between the input image signal 11 and the predictive image signal 16 already generated in the motion compensated predictor 108 and the predictive error signal 12 is generated (step S102).

An orthogonal transform of the predictive error signal 12 is performed in the orthogonal transformer 102 (step S103), and its orthogonal transform factor is quantized in the quantizer 103 (step S104). The orthogonal transform factor of the predictive error signal 12 quantized thus is then inputted to an entropy encoder 109 and encoding processing is performed.

Also, the orthogonal transform factor of the predictive error signal 12 quantized is inputted to the inverse quantizer 104 and is inversely quantized in the inverse quantizer 104 (step S105). Then, in the inverse orthogonal transformer 105, an inverse orthogonal transform is performed and a predictive error signal is reproduced (step S106).

Then, the predictive image signal 16 inputted to the substracter 101 in step S102 is added to the reproduced predictive error signal by the adder 106 and the locally decoded image signal 14 is generated (step S107) and is stored in the frame memory 107 (step S108).

Then, the locally decoded image signal 15 is read out of the frame memory 107 and is inputted to the motion compensated predictor 108. Here, the locally decoded image signal 15 read out of the frame memory 107 may be predefined so as to use a locally decoded image signal of the frame of a predetermined frame past with respect to the present frame, and may also be configured so that a locally decoded image signal read out of the outside can be specified separately. Also, it may be configured so that order of frames of an input image signal to be processed are replaced and a locally decoded image signal of the future frame is previously generated with respect to the present processed frame and is stored in the frame memory 107 and this locally decoded image signal can be read out to be used in a motion compensated prediction of the present processed frame.

In the motion compensated predictor 108, using a motion compensated prediction, the predictive image signal 16 is generated from the input image signal 11 and the locally decoded image signal 15 read out of the frame memory 107 (step S109).

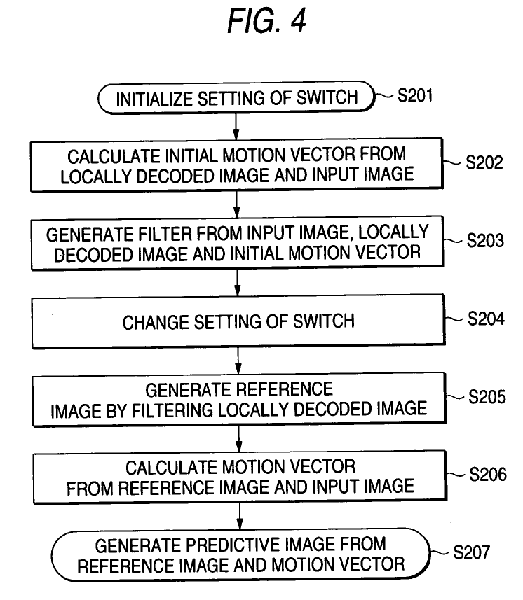

Here, an action of the motion compensated predictor 108 will be described using FIGS. 2 and 4. Incidentally, FIG. 4 is a flowchart showing an action of generating the predictive image signal 16 in the motion compensated predictor 108.

First, in the motion compensated predictor 108, states of the switch 201, the switch 203 and the switch 205 are initialized (step S201). That is, in the switch 201, the switch 203 and the switch 205, a terminal 201a, a terminal 203a and a terminal 205a become continuity states, respectively.

When settings of the switches are initialized, the input image signal 11 and the locally decoded image signal 15 are inputted to the motion detector 204 and a motion vector (hereinafter called an initial motion vector) between the input image signal 11 and the locally decoded image signal 15 is calculated in the motion detector 204 (step S202). As a method for calculating the motion vector from the two image signals, for example, a block matching method for dividing each of the image signals into plural areas (blocks) and searching the most similar block from the two image signals every block and setting a difference between positions on image signals between the searched blocks at a motion vector of its block can be used. In the block matching method, the motion vector is obtained in a block unit, so that the number of initial motion vectors becomes equal to the number of blocks. The initial motion vector detected by the motion detector 204 thus is then sent to the filter generator 206.

The filter generator 206 generates a filter for generating a reference image signal from the locally decoded image signal 15 using the initial motion vector, the input image signal 11 and the locally decoded image signal 15 (step S203).

Here, as the filter generated by the filter generator 206, for example, a filter for doing the linear sum of pixel values of pixels within a predetermined range including the full-pel pixel with respect to each of the full-pel pixels of the locally decoded image signal 15 may be generated. That is, when it is assumed that a pixel value of a pixel of coordinates (x, y) of the locally decoded image signal 15 is S_{L} (x, y), a pixel value S_{R} (x, y) of a pixel in coordinates (x, y) of the corresponding reference image signal shall be derived from a formula (1).

$${S}_{R} ( x , y ) = [ {\sum }_{i = - N}^{N} {\sum }_{j = - N}^{N} h ( i , j ) {S}_{L} ( x + i , y + j ) ] \qquad ( 1 )$$

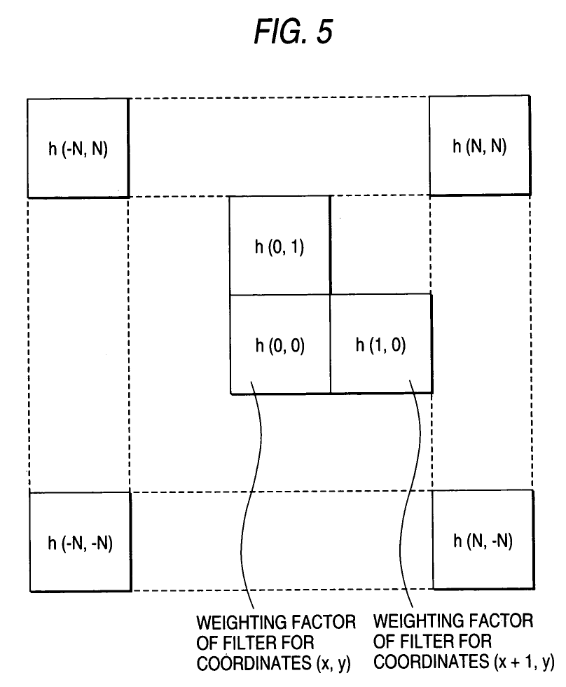

Here, as shown in FIG. 5, h (i, j) is a weighting factor of a filter for coordinates (x+i, y+j) and N is a constant representing a range of pixels for doing the linear sum, Also, [a] represents a value in which a real number a is rounded off.

In order to control the amount of computation for encoding, using a formula (2) instead of the formula (1), a value acquired by bit-shifting the linear sum of pixel values of full-pel pixels of the locally decoded image signal 15 by m bits to the right can be set at a pixel value of a reference image.

$${S}_{R} ( x , y ) = [ ( ( {\sum }_{i = - N}^{N} {\sum }_{j = - N}^{N} h ( i , j ) {S}_{L} ( x + i , y + j ) ) + {2}^{m - 1} ) m ] \qquad ( 2 )$$

Here, “>>” represents an operator meaning a right direction bit shift. Also, in the formula (2), the value acquired by m-bit shifting is rounded off, so that the bit shift is made after adding 2^{m-1} to the linear sum of pixel values of full-pel pixels of the locally decoded image signal 15. Also, m is a predetermined constant.

Further, as shown in a formula (3) instead of the formula (1), a value obtained by adding an offset h_{offset} to a value acquired by bit-shifting the linear sum of pixel values of full-pel pixels of the locally decoded image signal 15 by m bits to the right can also be set at a pixel value of a reference image.

$${S}_{R} ( x , y ) = [ ( ( ( {\sum }_{i = - N}^{N} {\sum }_{j = - N}^{N} h ( i , j ) {S}_{L} ( x + i , y + j ) ) + {2}^{m - 1} ) m ) + {h}_{offset} ] \qquad ( 3 )$$

Thus, the value obtained by adding the offset h_{offset} is set at the pixel value of the reference image and thereby, a filter in which the average luminance change of pixels of the whole image is also considered can be generated.

Also, as shown in a formula (4) instead of the formula (3), a value in which a value obtained by adding an offset to the linear sum of pixel values of full-pel pixels of the locally decoded image signal 15 is bit-shifted by m bits to the right may be set at a pixel value of a reference image.

$${S}_{R} ( x , y ) = [ ( ( ( {\sum }_{i = - N}^{N} {\sum }_{j = - N}^{N} h ( i , j ) {S}_{L} ( x + i , y + j ) ) + {h}_{offset} ) + {2}^{m - 1} ) m ] \qquad ( 4 )$$

Incidentally, the case of calculating a reference image signal will be described below using the formula (3) mentioned above.

The filter generator 206 obtains an offset value h_{offset} and a filter factor h(i, j) of a filter for the locally decoded image signal 15. The filter factor h(i, j) and the offset value h_{offset} are generated so as to minimize an error between the input image signal 11 and a predictive image signal acquired by performing motion compensation for a reference image signal by an initial motion vector. The motion compensation for the reference image signal by the initial vector could be made according to, for example, a formula (5).
S_{P}(x,y)=S_{R}(x−vₗᵢₓ,y−v_{liy}) (5)

Here, S_{P} (x, y) represents pixel values in coordinates (x, y) of the predictive image signal, and v_{Iix} and v_{Iiy} represent an x component and a y component of an initial motion vector V_{Ii} of a block i to which coordinates (x, y) belong, respectively.

Also, in the error between the input image signal 11 and the predictive image signal, for example, a square error expressed by a formula (6) or an absolute value error expressed by a formula (7) can be used.

$$\begin{matrix}{\sum }_{x , y} {( {S}_{P} ( x , y ) - S ( x , y ) )}^{2} & ( 6 ) \\ {\sum }_{x , y} \vert {S}_{P} ( x , y ) - S ( x , y ) \vert & ( 7 )\end{matrix}$$

Here, S (x, y) represents pixel values in coordinates (x, y) of the input image signal 11, and Sx,y represents the sum of all the pixels included in the image signal.

An offset value h_{offset} and a filter factor h(i, j) for minimizing the error between the input image signal 11 and the predictive image signal obtained by the formula (6) or the formula (7) can be obtained by solving a normalization equation of a method of least squares. Or, they may be obtained as a filter for approximately minimizing the error by an approximate minimization technique such as a Downhill Simplex method (for example, see J. R. Nelder and R. Mead, “A simplex method for function minimization,” Computer Journal, vol. 7, pp. 308-313, 1965).

The filter (h (i, j) and h_{offset}) generated by the filter generator 206 thus is sent to the reference image generator 202 and also is sent and stored in the filter memory 207. Further, in the subtracter 208, a difference between a filter already stored in the filter memory 207 and a filter generated by the filter generator 206 is computed and a difference signal 17 is generated. Here, as a filter for computing the difference between the filters, for example, a filter of the frame of one frame past with respect to the present frame could be used.

The difference between the filters is computed by, for example, a formula (8).
Δh(i,j)=h(i,j)−h_{M}(i,j)
Δh_{offset}=h_{offset}−h_{Moffset} (8)

Here, h_{M} (i, j) and h_{Moffset} are a filter factor and an offset value of the frame of one frame past stored in the filter memory. 207, respectively.

The difference signal 17 between the filters obtained thus is sent to the entropy encoder 109 and is encoded together with an orthogonal transform factor of the predictive error signal 12 quantized. Thus, the filter factor and the offset value are not encoded as they are and a difference between the filters generated and stored already is obtained and this difference is encoded and thereby, the amount of information to be encoded can be reduced.

When a filter is sent from the filter generator 206 to the reference image generator 202, settings of the switches are changed (step S204). That is, in the switch 201, the switch 203 and the switch 205, a terminal 201b, a terminal 203b and a terminal 205b become continuity states, respectively.

When the settings of the switches are changed, the locally decoded image signal 15 is inputted to the reference image generator 202 and a reference image signal is generated (step S205). The reference image signal is generated by filtering the locally decoded image signal 15 according to the formula (3) using the filter sent from the filter generator 206. The reference image signal generated by the reference image generator 202 is then sent to the motion detector 204 through the switch 203.

In the motion detector 204, a motion vector from the input image signal 11 and the reference image signal sent from the reference image generator 202 is calculated (step S206). As a method for calculating the motion vector, for example, the block matching method described above could be used. The calculated motion vector is sent to the predictive image generator 209 through the switch 205. Also, the calculated motion vector is sent to the entropy encoder 109 and is encoded together with the difference signal 17 between the filters sent from the subtracter 208 and the orthogonal transform factor of the predictive error signal 12 quantized.

In the predictive image generator 209, the predictive image signal 16 is generated from the reference image signal sent from the reference image generator 202 and the motion vector sent from the motion detector 204 (step S207) The predictive image signal 16 can be obtained according to a formula (9).
S_{P}(x,y)=S_{R}(x−vᵢₓ,y−v_{iy}) (9)

Here, vᵢₓ and v_{iy} represent an x component and a y component of a motion vector Vi of a block i to which coordinates (x, y) belong, sent from the motion detector 204, respectively.

The predictive image signal 16 generated by the predictive image generator 209 thus is then sent to the subtracter 101 and is used for generating the predictive error signal 12 between the predictive image signal 16 and an input image signal 11 inputted newly.

The above description is the action of the motion compensated predictor 108. Thus, the motion compensated predictor 108 generates a filter for the locally decoded image signal 15 every one frame, and generates the predictive image signal 16 for the input image signal 11 using this filter.

Next, the orthogonal transform factor of the predictive error signal 12 acquired and quantized by the quantizer 103, the motion vector 18 and the difference signal 17 between the filters for generation of the reference image signal obtained by the motion compensated predictor 108 are sent to the entropy encoder 109 and are encoded (step S110). As the entropy encoder 109, for example, an arithmetic encoder could be used.

These data encoded by the entropy encoder 109 are further multiplexed by a multiplexer 110 and are outputted as encoded data 19 of a bit stream. Then, the encoded data 19 is sent out to a transmission line or an accumulation system (not shown).

According to the video image encoding apparatus according to the first embodiment of the invention thus, a filter for a full-pel pixel of the locally decoded image signal 15 is generated so as to reduce an error between the predictive image signal and the input image signal and the predictive image signal 16 is generated from the input image signal 11 and the reference image signal generated using this filter and thereby, a predictive error between the predictive image signal 16 and the input image signal 11 can be reduced, so that degradation in image quality of the decoded image signal for the input image signal can be prevented.

Incidentally, in the first embodiment described above, a filter common to all the full-pel pixels of the locally decoded image signal 15 has been generated in the filter generator 206, but different filters can also be generated every block acquired by the motion detector 204. For example, a pixel value in coordinates (x, y) of a reference image signal shall be obtained by a formula (10) assuming that an offset and a filter factor for coordinates (x, y) of the locally decoded image signal 15 belonging to the k-th block are h_{koffset} and hₖ (i, j).

$${S}_{R} ( x , y ) = [ ( ( ( {\sum }_{i = - N}^{N} {\sum }_{j = - N}^{N} {h}_{k} ( i , j ) {S}_{L} ( x + i , y + j ) ) + {2}^{m - 1} ) m ) + {h}_{offset} ] \qquad ( 10 )$$

Then, the offset h_{koffset} and the weighting factor hₖ (i, j) of the filter could be defined every block so as to minimize a square error (formula (6)) or an absolute value error (formula (7)) between the input image signal 11 and the predictive image signal obtained by the formula (5). By generating the filter every block thus, the predictive error between the input image signal and the predictive image signal can be reduced further.

Also, plural blocks can be combined into a set to generate one filter every set unit of the blocks. By being configured thus, the predictive error between the predictive image signal and the input image signal can be reduced as compared with the case of generating the filter common to all the full-pel pixels of the locally decoded image signal 15 and also, the amount of computation for filter generation can be reduced as compared with the case of generating the filter every block.

Also, in the first embodiment described above, the bit shift amount used in the formula (3) or the formula (4) has been set at the predefined constant, but the bit shift amount can be varied according to encoding efficiency and this the bit shift amount can also be encoded and sent to a decoder. By varying the bit shift amount thus, the amount of information to be encoded can be controlled efficiently.

Also, in the first embodiment described above, the locally decoded image signal 15 read out of the frame memory 107 has been set at a locally decoded image signal of the frame of a predetermined predetermined time past, but, for example, it may be configured so that with respect to all the locally decoded image signals of a predetermined time past or future with respect to the present frame, predictive image signals are generated by the flowchart shown in FIG. 4 and the locally decoded image so as to minimize a predictive error between the predictive image signal and the input image signal is selected from among the predictive image signals.

Also, in the first embodiment described above, in step S207, the predictive image signal 16 has been generated using the reference image signal sent from the reference image generator 202 and the motion vector sent from the motion detector 204 in the predictive image generator 209, but it may be configured so that a configuration of the motion compensated predictor 108 is changed and a filter generated by the filter generator 206 and the locally decoded image signal 15 are directly sent to the predictive image generator 209 and the predictive image signal 16 is generated according to a formula (11) using the locally decoded image signal 15, the filter generated by the filter generator 206, and the motion vector sent from the motion detector 204.

$${S}_{P} ( x , y ) = [ ( ( ( {\sum }_{i = - N}^{N} {\sum }_{j = - N}^{N} h ( i , j ) {S}_{L} ( x - {v}_{kx} + i , y - {v}_{ky} + j ) ) + {2}^{m - 1} ) m ) + {h}_{offset} ] \qquad ( 11 )$$

Here, vₖₓ and v_{ky} represent an x component and a y component of a motion vector Vₖ of a block k to which coordinates (x, y) belong, sent from the motion detector 204, respectively.

### Second Embodiment

Next, a video image decoding apparatus according to a second embodiment will be described.

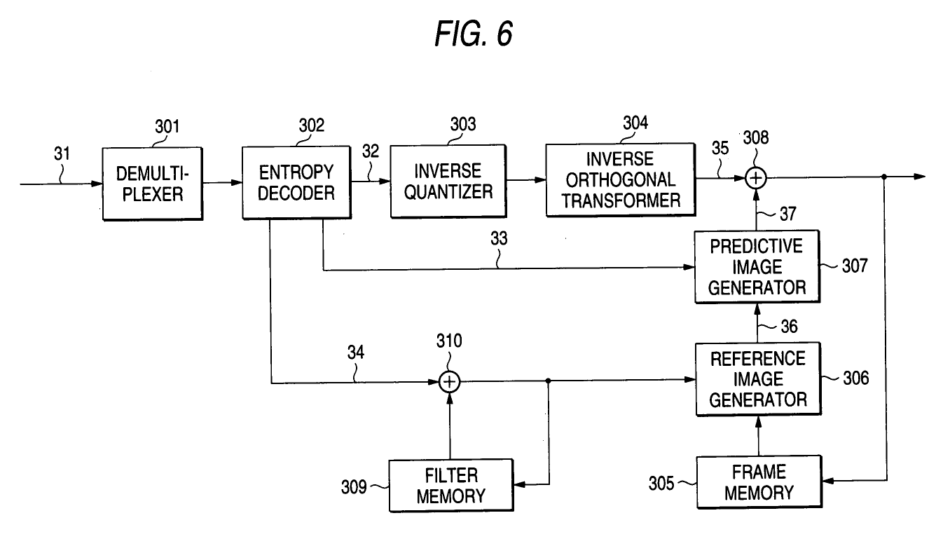

FIG. 6 is a block diagram showing a video image decoding apparatus according to the second embodiment.

The video image decoding apparatus according to the second embodiment includes a demultiplexer 301 for separating encoded data 31, an entropy decoder 302 for decoding an orthogonal transform factor 32 of a predictive error signal quantized, a motion vector 33 and a difference signal 34 of a filter for generation of a reference image signal from the encoded data separated by the demultiplexer 301, an inverse quantizer 303 for inversely quantizing the orthogonal transform factor 32 of the predictive error signal quantized, an inverse orthogonal transformer 304 for reproducing a predictive error signal 35 by performing an inverse orthogonal transform of the orthogonal transform factor of the predictive error signal, frame memory 305 for storing a decoded image signal decoded already, a reference image generator 306 for generating a reference image signal 36 by filtering the decoded image signal stored in the frame memory 305, a predictive image generator 307 for generating a predictive image signal 37 from the reference image signal 36 generated by the reference image generator 306 and the motion vector 33 sent from the entropy decoder 302, an adder 308 for adding the predictive image signal 37 generated by the predictive image generator 307 to the predictive error signal 35 reproduced by the inverse orthogonal transformer 304 and generating a decoded image signal, filter memory 309 for storing a filter reproduced, and an adder 310 for adding the filter stored in the filter memory 309 to the difference signal 34 of the filter sent from the entropy decoder 302 and thereby reproducing a filter and sending the filter to the reference image generator 306.

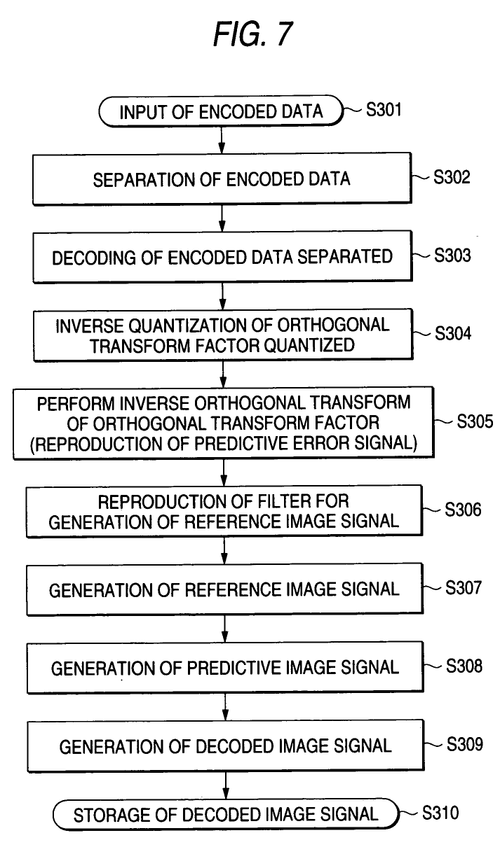

Next, an action of the video image decoding apparatus according to the second embodiment of the invention will be described using FIGS. 6 and 7. Incidentally, FIG. 7 is a flowchart showing an action of the video image decoding apparatus according to the second embodiment.

First, as the encoded data 31 of a decoding target, the encoded data 19 outputted from the video image encoding apparatus of FIG. 1 is inputted to the video image decoding apparatus shown in FIG. 6 through a transmission system or an accumulation system (step S301).

The encoded data 31 inputted is separated into encoded data of an orthogonal transform factor of a predictive error signal quantized, a difference signal of a filter for generation of a reference image signal and a motion vector in the demultiplexer 301 (step S302).

Each of the encoded data separated is then sent to the entropy decoder 302 and is decoded (step S303). The quantized orthogonal transform factor 32 of the predictive error signal decoded by the entropy decoder 302, the motion vector 33 and the difference signal 34 (Dh (i, j) and Dhoffset) of the filter for generation of the reference image signal are sent to the inverse quantizer 303, the predictive image generator 307 and the adder 310, respectively.

The orthogonal transform factor 32 of the predictive error signal quantized is first inversely quantized by the inverse quantizer 303 (step S304) and next, an inverse orthogonal transform is performed by the inverse orthogonal transformer 304 and the predictive error signal 35 is reproduced (step S305).

The difference signal 34 (Dₕ (i, j) and D_{hoffset}) of the filter for generation of the reference image signal sent to the adder 310 is added to a filter (h_{M} (i, j) and h_{Moffset}) stored in the filter memory 309 and a filter (h (i, j) and h_{offset}) in the present frame is reproduced (step S306). The filter could be reproduced according to a formula (12).
h(i,j)=Δh(i,j)+h_{M}(i,j)
h_{offset}=Δh_{offset}+h_{Moffset} (12)

Here, as the filter stored in the filter memory 309 used in reproduction of the filter, for example, when a difference signal between the filters is generated using the filter of one frame past with respect to the present frame in a video image encoder, the frame of one frame past could be read out of the filter memory 309 and be used accordingly.

The filter reproduced by the adder 310 is sent to the reference image generator 306 and also is sent to the filter memory 309 and is stored.

Then, in the reference image generator 306, a decoded image signal of a predetermined time past or future stored in the frame memory 305 is read out and is filtered using the filter sent from the adder 310 and the reference image signal 36 is generated (step S307). The reference image signal 36 is generated by a formula (13).

$${S}_{R} ( x , y ) = [ ( ( ( {\sum }_{i = - N}^{N} {\sum }_{j = - N}^{N} h ( i , j ) {S}_{D} ( x + i , y + i ) ) + {2}^{m - 1} ) m ) + {h}_{offset} ] \qquad ( 13 )$$

Here, S_{P} (x, y) represents a pixel value of a pixel in coordinates (x, y) of the decoded image signal stored in the frame memory 305. Also, as the decoded image signal read out, for example, when a reference image signal is generated using the locally decoded image signal of a predetermined frame past with respect to the present frame in a video image encoding apparatus, the decoded image signal of a predetermined frame past with respect to the present frame could be read out of the frame memory 305 and be used accordingly.

The reference image signal 36 generated by the reference image generator 306 is then sent to the predictive image generator 307.

In the predictive image generator 307, the predictive image signal 37 is generated using the reference image signal 36 and the motion vector 33 sent from the entropy decoder 302 (step S308). The predictive image signal 37 is generated by a formula (14).
S_{P}(x,y)=S_{R}(x−vᵢₓ,y−v_{iy}) (14)

Here, vᵢₓ and v_{iy} represent an x component and a y component of a motion vector Vᵢ of a block to which coordinates (x, y) belong, sent from the entropy decoder 302, respectively.

In the adder 308, the predictive image signal 37 generated by the predictive image generator 307 is added to the predictive error signal 35 sent from the inverse orthogonal transformer 304 and a decoded image signal is generated (step S309). Time series data of the decoded image signal generated thus results in a video image signal decoded.

Also, the decoded image signal outputted from the adder 308 is sent to the frame memory 305 and is stored (step S310).

According to the video image decoding apparatus according to the second embodiment of the invention thus, using a filter generated so as to reduce an error between a predictive image signal and an input image signal inputted to the video image encoding apparatus, a reference image signal 36 is generated and a predictive image signal 37 is generated from this reference image signal 36, so that degradation in image quality of the decoded image signal for the input image signal inputted to the video image encoding apparatus can be prevented.

As described with reference to the embodiments, a filter for a locally decoded image is generated so as to reduce an error between an input image and an image acquired by performing motion compensation for a reference image and a predictive image is generated from the reference image acquired using this filter, so that a predictive error between the input image and the predictive image can be reduced.

Hereinbelow, a brief overview of the above-described embodiments will be described in contrast with a related art techniques for predicting a pixel value S_{A} in an image to be encoded from a pixel value S_{B} in an image decoded from a previously encoded data.

In the description below, it is assumed that the images are formed in one plane (one-dimensionally) and not in two dimension for convenience of explanation. In the accompanying figures referred in the following description, full-pel pixels are shown in large dots (large circles) and a virtual pixel called a sub-pel pixel (pixel at sub-pel position) generated by applying a conventional interpolation filter are shown in small dots (small circles).

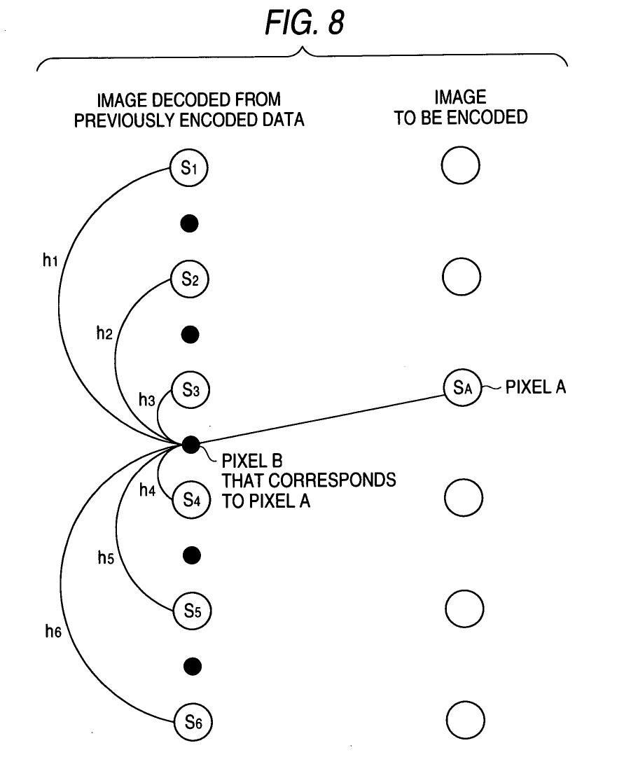

First, a conventional technique for predicting a pixel value S_{A} from a pixel value S_{B} by use of an interpolation filter will be explained with reference to FIG. 8. The sub-pel pixels shown as small dots in FIG. 8 are generated from the full-pel pixels by the interpolation filter. In this case, when determined by a motion vector search that a pixel that corresponds to a pixel “A” in an image to be encoded exists in between the full-pel pixels in an image decoded from a previously encoded data, a pixel value S_{A} for a pixel “A” is predicted by use of a pixel “B” that corresponds to the pixel “A” in the image decoded from a previously encoded data by a calculation shown in a formula (15).

$${\hat{S}}_{A} = {\sum }_{i - 1}^{6} {h}_{i} {S}_{i} \qquad ( 15 )$$

In the formula (15), the hatted S_{A} in the left side of the equal sign is a predicted value of the pixel value of the pixel “A”, and hᵢ is a weight value for each of the full-pel pixels Sᵢ.

Conceptually, as shown in FIG. 8, in the conventional technique that uses sub-pel pixels for predicting the pixel in the image to be decoded, the sub-pel pixel “B” is generated by interpolating the full-pel pixels, and the pixel “A” is generated by referring to the sub-pel pixel “B”.

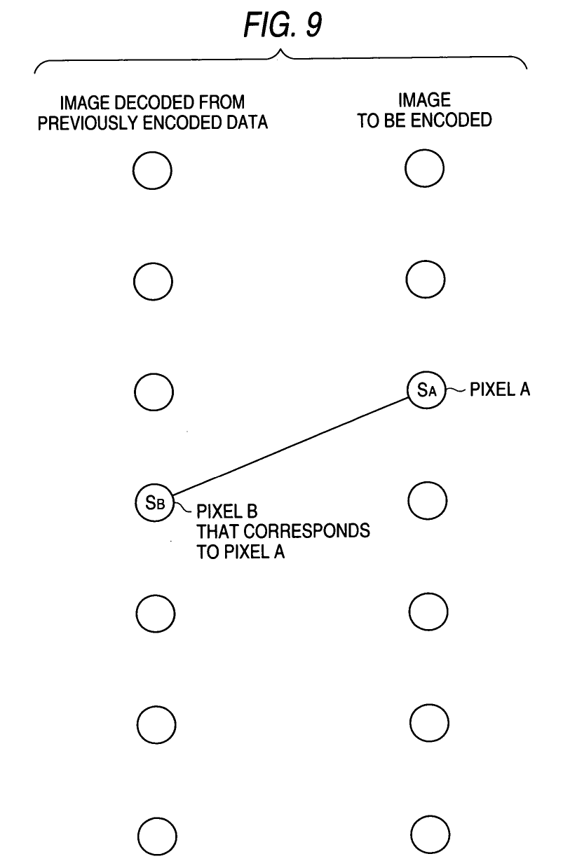

Next, a conventional weighted prediction method for predicting the pixel value S_{A} from the pixel value S_{B} will be explained with reference to FIG. 9.

In the weighted prediction method, when determined by a motion vector search that the pixel “A” in the image to be encoded corresponds to the pixel “B” in the image decoded from a previously encoded data, a pixel value S_{A} for the pixel “A” is predicted by a calculation shown in a formula (16).
Ŝ_{A}=αS_{B}+β (16)

In the formula (16), the hatted S_{A} in the left side of the equal sign is a predicted value of the pixel value of the pixel “A”, and α and β are weight values for the full-pel pixels S_{B}.

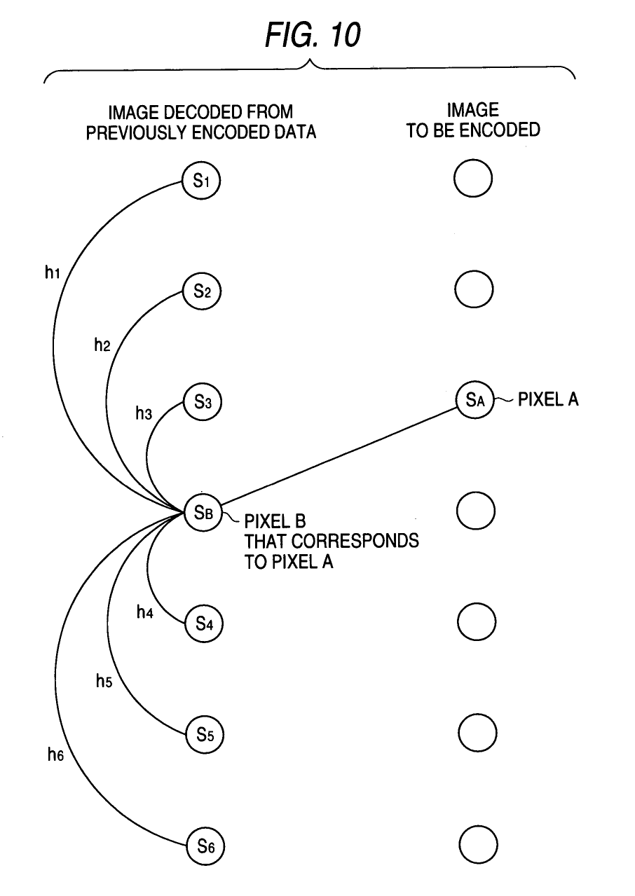

Next, a concept of the technique used in the above-described embodiments will be explained with reference to FIG. 10.

In the embodiments, when determined by a motion vector search that the pixel “A” in the image to be encoded corresponds to the pixel “B” in the image decoded from a previously encoded data, a pixel value S_{A} for the pixel “A” is predicted by a calculation shown in a formula (17).

$$\begin{matrix}{\hat{S}}_{A} = {\sum }_{i = 1}^{6} {h}_{i} {S}_{i} + {h}_{B} {S}_{B} + γ \\ = {\sum }_{i = 0}^{6} {h}_{i} {S}_{i} + γ ( when assumed {h}_{0} = {h}_{B} , {S}_{0} = {S}_{B} ) \end{matrix} \qquad ( 17 )$$

In the formula (17), the hatted S_{A} in the left side of the equal sign is a predicted value of the pixel value of the pixel “A”. In the polynomial equation in the right side at first row of the formula (17), the first two terms correspond to a filter for a full-pel pixel and the last two terms correspond to a filter used in the weighted prediction method.

The foregoing description of the embodiments has been presented for purposes of illustration and description. It is not intended to be exhaustive or to limit the invention to the precise form disclosed, and modifications and variations are possible in light of the above teachings or may be acquired from practice of the invention. The embodiment is chosen and described in order to explain the principles of the invention and its practical application program to enable one skilled in the art to utilize the invention in various embodiments and with various modifications as are suited to the particular use contemplated. It is intended that the scope of the invention be defined by the claims appended hereto, and their equivalents.

What is claimed is:

1. A video image encoding method comprising:
obtaining a first motion vector that indicates relevancy between an input image that is to be encoded and a locally decoded image that is decoded from an encoded image;
generating a filter for the locally decoded image, the filter that minimizes an error between the input image and an image obtained by performing motion compensation for a reference image using the first motion vector;
generating the reference image by filtering the locally decoded image by the filter;
obtaining a second motion vector that indicates relevancy between the input image and the reference image;
generating a predictive image by performing motion compensation for the reference image using the second motion vector; and
encoding a predictive error that is obtained by orthogonally transforming and quantizing a predictive error between the predictive image and the input image.

2. The video image encoding method according to claim 1, wherein the first motion vector is obtained for each of first unit blocks that divides the input image and the locally decoded image in a predetermined size, and
wherein the second motion vector is obtained for each of second unit blocks that divides the input image and the reference image in a predetermined size.

3. The video image encoding method according to claim 1, wherein the filter is for obtaining a weighted sum of pixel values of full-pel pixels of a predetermined range including a full-pel pixel with respect to each of the full-pel pixels in the locally decoded image.

4. The video image encoding method according to claim 1, wherein the filter is for bit-shifting, by a predetermined shift amount, a weighted sum of pixel values of full-pel pixels of a predetermined range including a full-pel pixel with respect to each of the full-pel pixels in the locally decoded image.

5. The video image encoding method according to claim 1, wherein the filter is for adding an offset to a value obtained by bit-shifting, by a predetermined shift amount, a weighted sum of pixel values of full-pel pixels of a predetermined range including a full-pel pixel with respect to each of the full-pel pixels in the locally decoded image.

6. The video image encoding method according to claim 1, wherein the filter is for bit-shifting, by a predetermined shift amount, a value obtained by adding an offset to a weighted sum of pixel values of full-pel pixels of a predetermined range including a full-pel pixel with respect to each of the full-pel pixels in the locally decoded image.

7. A video image encoding method comprising:
obtaining a first motion vector that indicates relevancy between an input image that is to be encoded and a locally decoded image that is decoded from an encoded image;
generating a filter for the locally decoded image, the filter that minimizes an error between the input image and an image obtained by performing motion compensation for a reference image using the first motion vector;
generating the reference image by filtering the locally decoded image by the filter;
obtaining a second motion vector that indicates relevancy between the input image and the reference image;
generating a predictive image by filtering by the filter an image acquired by performing motion compensation for the locally decoded image using the second motion vector; and
encoding a predictive error that is obtained by orthogonally transforming and quantizing a predictive error between the predictive image and the input image.

8. The video image encoding method according to claim 7, wherein the first motion vector is obtained for each of first unit blocks that divides the input image and the locally decoded image in a predetermined size, and
wherein the second motion vector is obtained for each of second unit blocks that divides the input image and the reference image in a predetermined size.

9. The video image encoding method according to claim 7, wherein the filter is for obtaining a weighted sum of pixel values of full-pel pixels of a predetermined range including a full-pel pixel with respect to each of the full-pel pixels in the locally decoded image.

10. The video image encoding method according to claim 7, wherein the filter is for bit-shifting, by a predetermined shift amount, a weighted sum of pixel values of full-pel pixels of a predetermined range including a full-pel pixel with respect to each of the full-pel pixels in the locally decoded image.

11. The video image encoding method according to claim 7, wherein the filter is for adding an offset to a value obtained by bit-shifting, by a predetermined shift amount, a weighted sum of pixel values of full-pel pixels of a predetermined range including a full-pel pixel with respect to each of the full-pel pixels in the locally decoded image.

12. The video image encoding method according to claim 7, wherein the filter is for bit-shifting, by a predetermined shift amount, a value obtained by adding an offset to a weighted sum of pixel values of full-pel pixels of a predetermined range including a full-pel pixel with respect to each of the full-pel pixels in the locally decoded image.

13. A video image encoding apparatus comprising:
a motion estimation unit that obtains a first motion vector that indicates relevancy between an input image that is to be encoded and a locally decoded image that is decoded from an encoded image, and a second motion vector that indicates relevancy between the input image and a reference image that is obtained by filtering the locally decoded image by a filter;
a filter generation unit that generates the filter for the locally decoded image, the filter that minimizes an error between the input image and an image obtained by performing motion compensation for the reference image using the first motion vector;
a reference image generation unit that generates the reference image by filtering the locally decoded image by the filter; and
a predictive image generation unit that generates a predictive image by performing motion compensation for the reference image using the second motion vector.

14. The video image encoding apparatus according to claim 13, wherein the motion estimation unit obtains the first motion vector for each of first unit blocks that divides the input image and the locally decoded image in a predetermined size, and
wherein the motion estimation unit obtains the second motion vector for each of second unit blocks that divides the input image and the reference image in a predetermined size.

15. A video image decoding method comprising:
decoding an encoded data to obtain a quantized orthogonal transform factor, a motion vector, and a filter for generating a reference image;
generating a predictive error signal by performing an inverse quantization and an inverse orthogonal transform for the quantized orthogonal transform factor;
generating the reference image by filtering a decoded image by the filter;
generating a predictive image from the reference image and the motion vector;
generating the decoded image from the predictive image and the predictive error signal.

16. A video image decoding apparatus comprising:
a decoding unit that decodes an encoded data to obtain a quantized orthogonal transform factor, a motion vector, and a filter for generating a reference image;
a signal generating unit that generates a predictive error signal by performing an inverse quantization and an inverse orthogonal transform for the quantized orthogonal transform factor;
a reference image generating unit that generates a reference image by filtering a decoded image by the filter;
a predictive image generating unit that generates a predictive image from the reference image and the motion vector; and
a decoded image generating unit that generates the decoded image from the predictive image and the predictive error signal.
